(19) United States
(12) Patent Application Publication
(10) Pub. No.: US 2006/0152452 A1
(43) Pub. Date: Jul. 13, 2006

(54) Electroluminescent display device with duty cycle control

(75) Inventors: Jurgen Jean Louis Hoppenbrouwers, Eindhoven (NL); Roel Van Woudenberg, Eindhoven (NL); Nijs Cornelis Van Der Vaart, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/563,647

(22) PCT Filed: Jul. 1, 2004
(86) PCT No.: PCT/IB04/51093

§ 371 Date: Jan. 6, 2006

(30) Foreign Application Priority Data
Jul. 9, 2003 (EP) 03102070.4

(51) Int. Cl. G09G 3/30

(52) U.S. Cl. 345/77

(57) ABSTRACT

The display device comprises a display panel (2) having a plurality of display pixels (4) with emissive display elements (11). The display device further comprises duty cycle control means (15, T3) for varying a fraction of the frame period during which the display pixels (4) emit light in dependence on an overall brightness level of an image to be displayed on the display panel. In order to vary the duty cycle a switch, e.g. a power transistor (T3) is connected between the drive transistor (T2) and the light emitting element (11) of each pixel (4) each pixel in a row may be connected to a single duty cycle select line (15).

The invention relates to a display device comprising a display panel having a plurality of display pixels with emissive display elements, an integrated circuit and a method for controlling such a display.

Although new display technologies rapidly emerge, people are still used to cathode ray tube (CRT) displays as e.g. employed for conventional TV-sets or monitors. One of the effects people are familiar with and appreciate in CRT displays is the ‘sparkling effect’ or ‘peak white’, i.e. the effect of more brightness for bright areas in otherwise dim images. In a CRT display this effect occurs by the electron gun providing more beam current (and hence more brightness) if only a part of the display shows a bright area. Indeed if the electron gun provides a large bright area, the beam current of the electron gun has to be limited resulting in a reduction of the brightness. However, if only a small area is bright in an otherwise dark scene, there is no need for limiting the beam current.

Display devices employing display elements, such as emissive display electroluminescent light emitting elements deposited on or over a substrate, are becoming increasingly popular. These light emitting elements may be light emitting diodes (LED's), incorporated in or forming display pixels that are arranged in a matrix of rows and columns. The materials employed in such LED's are suitable to generate light if a current is driven through these materials, such as particular polymeric (PLED) or small molecule organic (SMOLED) materials. Accordingly the LED's have to be arranged such that current can flow through these light emitting materials.

Typically passively and actively driven matrix displays are distinguished. For active matrix PLED (AMPLED) displays, the display pixels themselves comprise active circuitry such as one or more transistors. This active circuitry generates the current driven through the PLED material to generate or emit light. Such a display is addressed row at a time and the light emitting elements emit light during the remainder of the frame period. It is a disadvantage that new display technologies lack the sparkling effect of CRT-displays.

It is therefore an object of the invention to provide a display device comprising a plurality of display pixels having emissive display elements that is adapted to generate the sparkling effect. The invention is defined by the independent claims. The dependent claims define advantageous embodiments.

The object is achieved by providing a display device that comprises a display panel having a plurality of display pixels with emissive display elements and duty cycle control means for varying a fraction of a frame period during which said display pixels emit light in dependence on an overall brightness level of an image to be displayed on said display panel. By determining the overall brightness level for each frame period, the occurrence of a dim frame is detected and as a result the effective brightness of the display pixels in the dim frame can be boosted by increasing the fraction of the frame period during which the display pixels emit light. When the overall brightness level is high, the effective brightness of the display pixels can be dimmed by decreasing the fraction of the frame period during which the display pixels emit light. Consequently the sparkling effect can be obtained for the dim frames. Furthermore the power consumption of the display device is reduced for images with high overall brightness levels. Also, the range of available grey scale levels is not influenced by varying the above indicated fraction.

In an embodiment of the invention the display device comprises a a frame memory for storing input signals, representing said image, during a frame period for enabling a determination of the overall brightness level of the image during the frame period. This memory provides the possibility to determine the overall brightness level per frame or per set of frames. The frame memory allows to store the input signals for one frame period before providing the signals to the display panel. During this frame period the overall brightness level of the image corresponding to this frame may be determined. Based on this overall brightness level the fraction can be determined which should be applied during this frame period.

The device may further comprise a look up table for determining the fraction corresponding with the determined overall brightness level. This look-up table may contain data relating to the appropriate fraction for a particular overall brightness level for a frame.

In an embodiment of the invention the display pixels comprise a switch coupled to said control means for enabling light emission by said corresponding emissive display element for said fraction of said frame period. Such a switch preferably comprises a transistor connected in series to the electroluminescent element such that the current flow through the electroluminescent elements can be controlled by means of the transistor.

The invention further relates to a method for controlling a display panel having a plurality of display pixels with emissive display elements comprising the steps of:
determining an overall brightness level of an image to be displayed in a frame period on said display, and
controlling a fraction of said frame period during which said display pixels (4) emit light in dependence on said overall brightness level.

U.S. Pat. No. 5,451,979 discloses a display sign comprising a plurality of lights that are separately energized to produce an image. The display sign comprises a processor for controlling the duration of a duty cycle for energizing said lights. The processor includes means for determining the number of lights to be energized and means for reducing the duty cycle when the number of lights drops below a determined number. The display sign is neither arranged nor has as a purpose to cause the sparkling effect as the processor does not determine the overall brightness level for a frame, thus lacking the means for detecting a dim frame.

The non-prepublished patent application GB 0220512 (“Electroluminescent display devices”) of the applicant describes an active matrix electroluminescent display device comprising means for determining an overall brightness level of an image to be displayed in a frame period and means for controlling a drive transistor in dependence on a respective input signal providing a drive level for a display pixel and in dependence on the overall brightness level. According to the present invention the drive transistor is not controlled by the control means.

The invention will be further illustrated with reference to the attached drawings, in which:

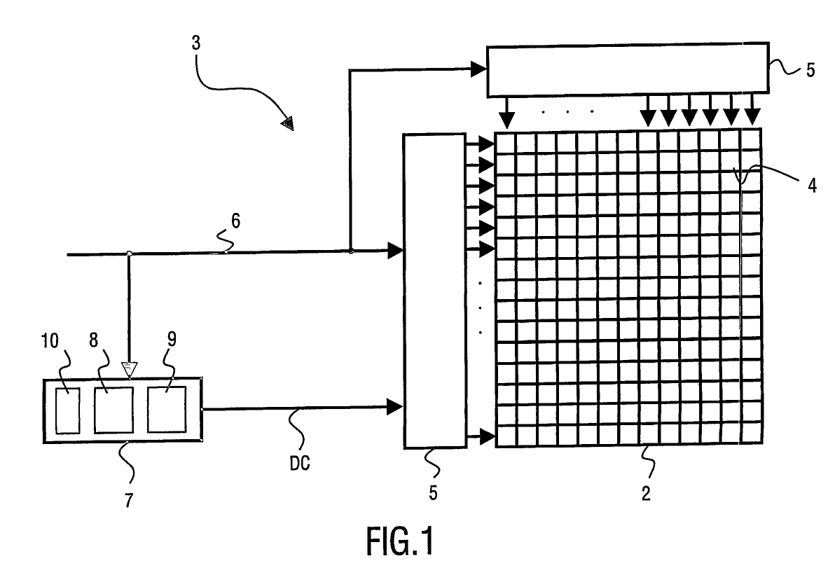

FIG. 1 shows a display device according to an embodiment of the invention; and

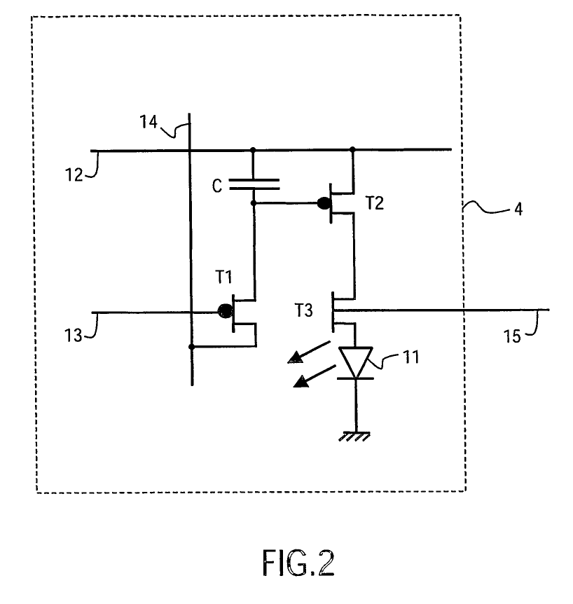

FIG. 2 shows a display pixel according to an embodiment of the invention.

FIG. 1 shows a schematic illustration of a display device 3. The display device 3 comprises the PLED display panel 2 having a plurality of display pixels 4 arranged in a matrix of rows and columns. It should be appreciated that FIG. 1 shows only a few display pixels 4. In practice there may be several hundreds of rows and columns with display pixels 4.

The display device 3 further comprises a driver circuitry arrangement 5 for addressing and data provision of the individual display pixels 4. The driver circuitry arrangement 5 comprises a data-input 6 for receiving a signal representing a video image to be displayed on the display panel 2. The image load or overall brightness level of the image received at the data-input 6 is determined by duty cycle control means 7. The control means 7 may consist of an adder 10, a memory 8, a loop-up table 9, herein after-also called a LUT, and other logic circuitry (not shown). Alternatively the control means may be a processor with associated memory and software performing the functions of adding, storing and other logic functions. The control means 7 may also comprise a combination of hardware and software to perform the mentioned functions, or be completely realized by software. The adder adds the values of the grey levels of each display pixel 4 for a frame. The total of the values of the grey levels may be stored in the memory and used as a measure of the image load for the display pixels 4 for that particular frame. Alternatively an average value of the values of the grey levels of the pixels 4 within a frame may be used as the measure of the image load.

Alternatively, if the color components red R, green G and blue B of the video image are available, the luminance values of these signals may be added.

As a further alternatively, the total luminance value of each of the color components may be determined.

A combination of the respective total luminance value of the color components may be used to represent the image load.

In the example of FIG. 1, the memory 8 comprises the total of the values of the grey levels for a current frame being displayed.

The LUT 9 comprises a list of duty cycle values to be selected as function of the total of the grey level values. The duty cycle is defined as a percentage, indicating the fraction of the frame period of the input signal, during which a display pixel 4 is driven to emit light.

Below an example of the contents of a LUT 9 is depicted for use with a display panel 2 providing a nominal brightness of 100% at a duty cycle of 50%.

TABLE 1

| OBV (%) | DC (%) | EPB (%) |
|---|---|---|
| 100 | 35 | 70 |
| 90 | 35 | 70 |
| 80 | 35 | 70 |
| 70 | 35 | 70 |
| 60 | 35 | 70 |
| 50 | 40 | 80 |
| 40 | 45 | 90 |
| 30 | 50 | 100 |
| 20 | 55 | 110 |
| 15 | 60 | 120 |
| 10 | 65 | 130 |
| 5 | 75 | 150 |

Table 1 illustrates that when the video image has an overall brightness level (OBV) of 5%, the duty cycle (DC) is increased to 75% via the driver circuitry arrangement 5 by control means 7 of the display device 3. This results in a boost by a factor 1.5 of the effective pixel brightness (EPB) compared to the nominal brightness. Thus the peak brightness is substantially increased for video images having a relatively low overall brightness level. This provides the desired sparkling effect.

The control means 7 may determine the image load and the corresponding duty cycle of a current frame of the video image while the image load and the corresponding duty cycle of a previous frame is used to display the current video image.

Alternatively a frame memory (not shown) may be applied to delay the video image with a frame period prior to supplying the video image received at the data input 6 to the drive circuitry arrangement 5. This enables the control means 7 to determine the duty cycle to be applied to a current frame prior to displaying this current frame.

The increase of the duty cycle may induce sample/hold artifacts for the display panel 2. Sample/hold artefacts arise from the fact that in every frame period, a new image may be displayed at the start of the frame period (sample), whilst in remainder of the frame period (typically 16 msec for 60 Hz operation) the image remains visible on the screen (hold). For moving video images, the eye tries to follow the image across the screen of the display panel 2, whilst, due to the sample/hold nature of the addressing, the image is physically stationary. The user interprets this effect as a blurred image. However, users generally prefer the sparkling effect over moving image quality. Furthermore, when the duty cycle has low values (e.g. DC<50%) a small increase of the duty cycle will result in a large brightness increase without increasing the motion blurring effect noticeably.

The display device may be a display module for incorporating in a display product. The display device may also be a product like a television set, monitor, personal digital assistant, camera, computer, phone or any other product having a display screen. Such a product includes next to the display module also a housing and other features like, for example, controls and a power supply.

FIG. 2 shows an example of a display pixel 4 arranged to enable control of the duty cycle. The display pixel 4 is a voltage controlled display pixel comprising an addressing transistor T1, a storage capacitor C and a drive transistor T2 for driving an electroluminescent display element 11. T2 may be a p-Si thin film transistor (TFT) and light emitting element 11 may be a light emitting diode, such as a polymer or small molecule OLED. One of the plates of the capacitor C and the source electrode of T2 are connected to a voltage supply line 12. Addressing of the display pixel 4 is performed via line 13, while the data received via the data-input 6 is transmitted via data line 14.

It is noted that the duty cycle may be varied in various ways. In a preferred embodiment a switch T3, such as a power transistor, is applied. The switch T3 can be addressed over a duty cycle select line 15 that is controlled by the control means 7. Thus, in operation, the control means 7 determine the overall brightness level for a particular frame and vary the duty cycle in dependence on the determined overall brightness level, for example, according to the LUT 9, via the duty cycle select line 15. The switches T3 of each display pixel 4 in a row may be connected to a single duty cycle select line 15, such that all display pixels 4 of a particular row are subject to the same duty cycle. Two or more select line 15 may be combined in groups of select lines 15 in order to reduce the number of connections to be made to the display panel 2.

The invention is not restricted to the above described embodiments which can be varied in a number of ways within the scope of the claims, e.g. by arranging the switch T3 between the display element 11 and ground. Several different display pixels 4 can be envisaged incorporating the invention. The invention can also be applied to other matrix displays that are driven with a duty cycle and have emissive display elements like active matrix field emission displays.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Display device (3) comprising a display panel (2) having a plurality of display pixels (4) with emissive display elements (11); and duty cycle control means (7) for varying a fraction of a frame period during which said display pixels (4) emit light in dependence on an overall brightness level of an image to be displayed on said display panel (2).

2. Display device (3) according to claim 1, wherein said control means (7) are adapted to increase said fraction if a decrease of said overall brightness level is determined.

3. Display device (3) according to claim 1 wherein said control means (7) are adapted to decrease said fraction if an increase of said overall brightness level is determined.

4. Display device (3) according to claim 1, further comprising a frame memory for storing input signals, representing said image, during a frame period for enabling a determination of the overall brightness level of the image during the frame period.

5. Display device (3) according to claim 1, wherein the control means (7) are adapted to determine the fraction of the frame period in dependence on the overall brightness level of the image during a previous frame period.

6. Display device (3) according to claim 1, wherein the control means (7) further comprise a look-up table (9) for determining said fraction corresponding with said determined overall brightness level.

7. Display device (3) according to claim 1, wherein said display pixels (4) comprise a switch (T3) coupled to said control means (7) for enabling light emission by said corresponding emissive display element (11) for said fraction of said frame period.

8. Method for controlling a display panel (2) having a plurality of display pixels (4) with emissive display elements (11) comprising the steps of:
determining an overall brightness level of an image to be displayed in a frame period on said display, and
controlling a fraction of said frame period during which said display pixels (4) emit light in dependence on said overall brightness level.

9. Integrated circuit for controlling a display panel (2) having a plurality of display pixels (4) with emissive display elements (11), the integrated circuit comprising a duty cycle control arrangement (7) for varying a fraction of a frame period during which said display pixels (4) emit light in dependence on an overall brightness level of an image to be displayed on said display panel (2).
